(19) United States
(12) Patent Application Publication
(10) Pub. No.: US 2026/0024265 A1
(43) Pub. Date: Jan. 22, 2026

(54) ANIMATABLE IMAGE GENERATOR FOR INTERACTIVE IMMERSIVE EDUCATIONAL EXPERIENCES USING INTEGRATED PROGRAMMATIC CONTROLLED AND SPECIALIZED GUIDED AND CONSTRAINED ARTIFICIAL INTELLIGENCE

(71) Applicant: 2hr Learning, Inc., Austin, TX (US)

(72) Inventors: Niraj Patel, London (GB); Janet Demir, Ortaca (TR); Akshay Mate, Nanaimo (CA); Matthew Caponi, Vancouver, WA (US)

(73) Assignee: 2hr Learning, Inc., Austin, TX (US)

(21) Appl. No.: 19/273,050

(22) Filed: Jul. 17, 2025

Related U.S. Application Data
(60) Provisional application No. 63/672,370, filed on Jul. 17, 2024.

(51) Int. Cl. G06T 13/40; G06T 5/60; G06T 13/20; G09B 5/06

(52) U.S. Cl. CPC G06T 13/40; G06T 5/60; G06T 13/205; G09B 5/065

(57) ABSTRACT

An animatable image generation system and method to guide the AI engine in generating a photorealistic image of the virtual character for animating the virtual character. The method starts with the selection of a virtual character based on the educational content provided to the user on the online learning platform. The data collector accesses the databases to collect information about the virtual character. Based on the selected virtual character, AI-driven prompts are generated to guide the AI engine to generate a photorealistic image of the virtual character.

### CROSS-REFERENCE TO RELATED APPLICATION(S)

This application claims the benefit under 35 U.S.C. § 119(c) and 37 C.F.R. § 1.78 of U.S. Provisional Application No. 63/672,370, which is incorporated by reference in its entirety.

### BACKGROUND OF THE INVENTION

### Field of the Invention

The present invention relates in general to the field of electronics, and more specifically to generate animatable photorealistic virtual characters integrated programmatic and specialized guided and constrained artificial intelligence to enhance the immersiveness of educational content by allowing the students to interact with the lifelike animations of the virtual character.

### Description of the Related Art

The educational platform displays historical figures which provide information on the education content which utilizes images, textual content, and generic video to explain the concepts related to the education curriculum. The historical figures are figures of the past having contextual knowledge about the specific education curriculum. The historical figures are generated using a 2D animation. Typically the 2D animation provides a visually engaging experience with the historical figures. While the historical figures may provide a visually engaging experience, the 2D animation does not offer a level of depth and realism. Moreover, the flat nature of 2D animation though providing engaging content might not be able to provide realism which enhances the learning experience.

The historical figures can be generated using computer-generated imagery (CGI). The formation of historical figures using CGI allows for the creation of detailed and customizable animations of historical figures. It can be highly realistic depending on the skill of the CGI artists and the resources allocated. However, the production times of CGI are usually high and require significant expertise in 3D modeling which may not be readily available in educational institutions.

Traditional educational platforms have relied on educational materials involving historical figures. The historical figures are represented as a photograph along with a written description of the historical figures. The representation provides the user, knowledge of the historical figure related to a particular education curriculum. While the historical figures give brief descriptions of the course, there might be a passive learning engagement that does not engage with students interactively.

Conventionally video content allows users to get information about the education curriculum. While the video content is engaging and in documentary style, it lacks the immersive and interactive element.

### SUMMARY

In at least one embodiment, a method integrates programmatic control and a guided and constrained Artificial Intelligence (AI) engine to generate a photorealistic image of a virtual character in correspondence to educational content provided to a user using an online learning platform. The method includes executing code using one or more processors of a computer system to cause the computer system to perform operations. The operations include selecting the virtual character based on the educational content provided to the user using the online learning platform. The operations include accessing historical databases and educational databases to collect information about the virtual character. The operations include generating a prompt to guide the AI engine to generate the photorealistic image of the virtual character. The operations include transferring the prompt to the AI engine to create the photorealistic image of the virtual character by converting the text prompt into the photorealistic image based on one or more parameters. The operations include receiving the photorealistic image of the virtual character in correspondence to the educational content items, where the generated image is generated specifically to enhance user engagement and experience that is visually appealing and contextually appropriate.

In at least one embodiment, a system integrates programmatic control and a guided and constrained Artificial Intelligence (AI) engine to generate a photorealistic image of a virtual character in correspondence to educational content provided to a user using an online learning platform. The system includes one or more processors of a computer system and a memory, coupled to the one or more processors, storing code that, when executed, causes the computer system to perform operations. The operations include selecting the virtual character using a selector based on the educational content provided to the user using the online learning platform. The operations include accessing historical databases and educational databases to collect information about the virtual character using a data collector. The operations include generating a prompt using a prompt generator to guide the AI engine to generate the photorealistic image of the virtual character. The operations include transferring the prompt to the AI engine to create the photorealistic image of the virtual character by converting the text prompt into the photorealistic image based on one or more parameters using an AI image generator. The operations include receiving the photorealistic image of the virtual character in correspondence to the educational content items using a display module, where the generated image is generated specifically to enhance user engagement and experience that is visually appealing and contextually appropriate.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary animatable image generation environment 100 to generate animations of historical figures using an animatable image generation system 110.

FIG. 2 depicts an exemplary animatable image generation process 200 utilized by animatable image generation environment 100.

FIG. 3 depicts a flowchart 300 to generate animatable images of the virtual character.

FIG. 4 depicts a data structure 400 used for the generation of an animatable photorealistic image of the virtual character using an AI image generator 120.

FIG. 5 depicts a user interface 500 displaying photorealistic image 500 generated using AI image generator 120.

FIG. 6 depicts a user interface 600 displaying photorealistic image 600 generated using AI image generator 120.

FIG. 7 depicts an exemplary network environment in which the system of FIG. 1 and the process of FIG. 2 may be practiced.

FIG. 8 depicts an exemplary computer system.

### DETAILED DESCRIPTION

An animatable image generation method and system to guide the AI engine in generating a photorealistic image of a virtual character. The selector within the animatable image generation system selects the virtual character based on the course the user is studying on the online learning platform. The selector selects the virtual character from the virtual character by a standard database. The virtual character by standard database includes a list of virtual characters mapped to the courses and standards to which they belong. The data collector integrated into the animatable image generation system collects the details of the virtual character from the selector and accesses information from the virtual character database. The details include the figure's name, age, sex, bio, etc.

The prompts are generated to guide the AI image generator in generating a photorealistic animatable image of the virtual character. Various parameters are required to generate an animatable photorealistic image which includes the image should face the camera, the aspect ratio should be 9:16. Furthermore, some images are generated that don't look directly at the camera and thus are not suitable for animation can lead to distortion, Variation in AI prompts are provides to generate the image using the more specific parameters. This enhances the immersivity of educational content by allowing students to interact with lifelike animations of historical figures, thereby making learning more engaging and memorable.

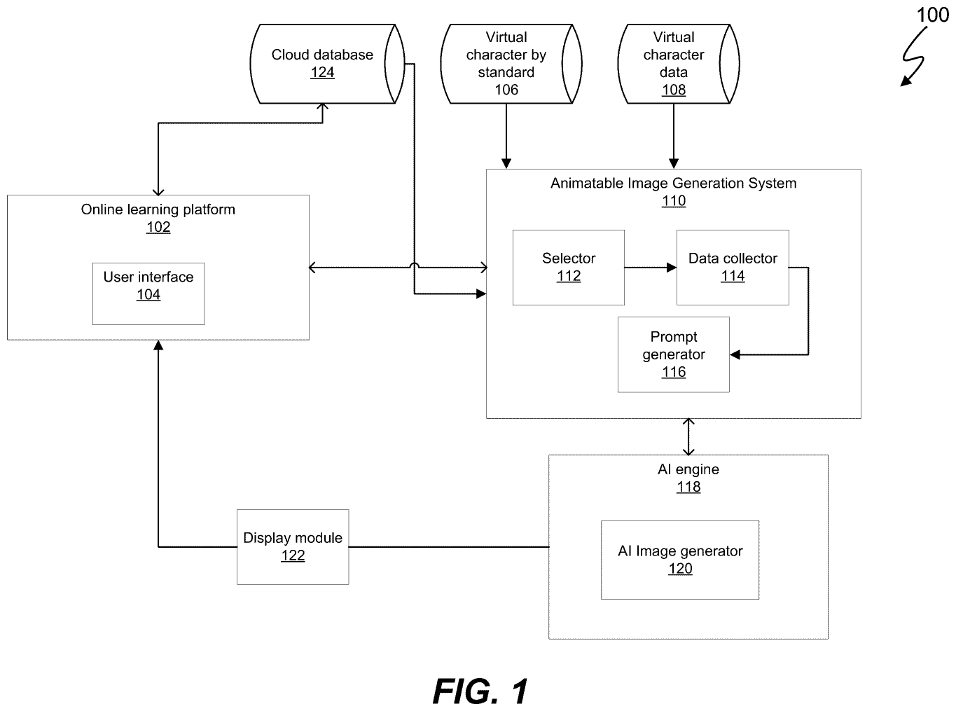

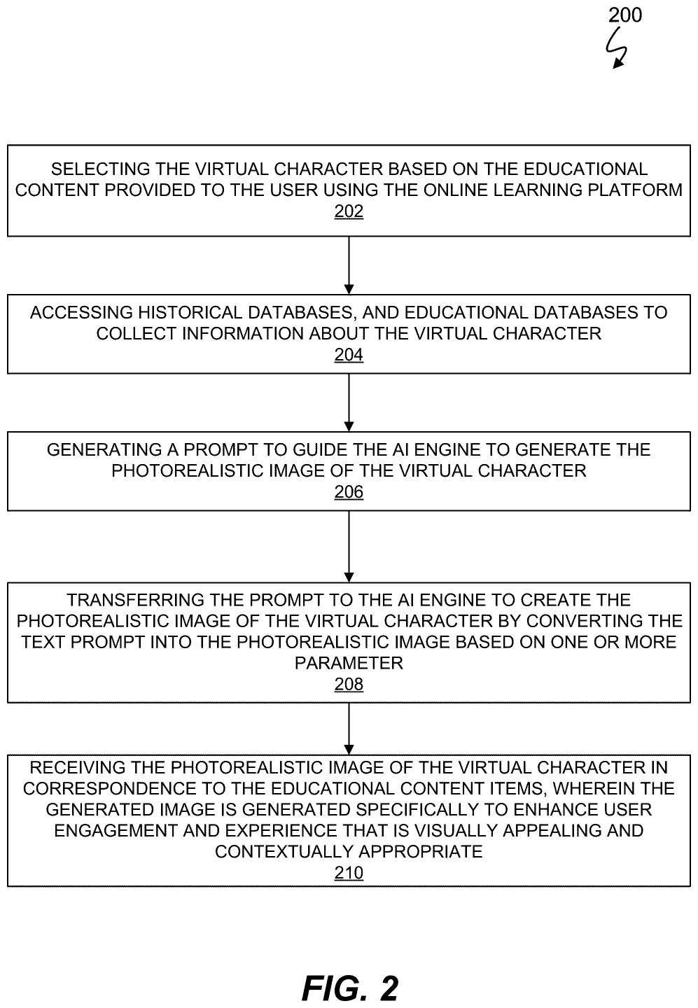

FIG. 1 depicts an exemplary animatable image generation environment 100 to generate animations of historical figures using an animatable image generation system 110. FIG. 2 depicts an exemplary animatable image generation process 200 utilized by animatable image generation environment 100.

Referring to FIGS. 1 and 2, in operation 202, a selector 112 selects a virtual character based on the educational content provided to a user on an online learning platform 102.

The online learning platform 102 is operatively coupled to an animatable image generation system 110. The animatable image generation system 110 depicts an environment to generate animatable images of virtual characters. The virtual characters represent artificial intelligence-generated real-time tutors to guide the user on an educational topic. The real-time tutor represents a figure from the past or a modern day, whose deeds significantly impacted people's lives. The real-time tutor represents a character best suited to deliver a chosen educational content. The real-time tutor is trained in educational content to provide helpful explanations related to the educational topic or standard. For instance, a user studying AP history course may seek information related to the topic from the historical figure of Abraham Lincon.

A user is presented with educational content related to a course via a user interface 104 of the online learning platform 102. The course is split into multiple units and each unit has multiple topics. Each topic is linked to one or more educational standards. For instance, an AP biology course has units and each unit has various standards that provide educational content on different standards of biology and include educational content topics like “photosynthesis”, “evolution” and so on.

The user logs onto the online learning platform 102 and is presented with educational content to master a particular topic. The user starts learning a course on the user interface 104 of the online learning platform 102. The selector 112 is integrated into the animatable image generation system 110. The selector 112 selects a virtual character based on academic content presented to the user on the online learning platform 102. The selector 112 selects a virtual character from a virtual character by standard database 106. The virtual character by standard database 106 includes a list of historical figures mapped to each course and standard. For each standard of the course, five virtual characters are tagged. The selector 112 selects the virtual character based on the appropriateness of the character to the educational content the user is studying. For instance, if the user is studying AP Biology on the user interface 104 of the online learning platform 102, belonging to standard “IST-2.C.2+1”, the selector 112 will select virtual characters related to the particular standard such as “Barbara McClintock”, “Rosalind Franklin”, “Francis Frank”, “James Watson”, and “Max Delbruck. The virtual character by standard database 106 includes a list of 2000+ figures mapped to various standards and courses.

In at least one of the embodiments, the GPT-4 is used to map virtual characters to each standard by providing a prompt to the GPT-4.

In operation 204, a data collector 114 accesses information from a virtual character data 108 to collect information about the virtual character.

The data collector 114 is integrated into an animatable image generation system 110. The data collector 114 accesses information from the virtual character data 108. The data collector 114 collects details of the virtual character from the selector 112. The data collector 114 accesses the virtual character data 108 to access the information on the virtual character based on content provided to the user on the online learning platform 102. The virtual character data 108 includes information on the virtual characters. The details of the virtual character include the name of the virtual character, bio, sex, country, biographic data, age, and, voice, era, and so on.

The inputs from the data collector 114 generate an animatable photorealistic image of the virtual character. For instance, if the user is studying AP United history data collector 114 fetches information from selector 112 and accesses the information on virtual characters related to American history to generate an animatable photorealistic image of Abraham Lincon, Thomas Jefferson, Harriet Tubman, Alexander Hamilton, Susan B. Anthony. For instance, the details of “Abraham Lincon” include bio—“16th US President”, era—“19th century”, sex—“male”, country—“United States”, Age—“middle age” and so on.

In operation 206, a prompt generator 116 is utilized to guide the AI engine 118 in generating the animatable photorealistic image of the virtual character.

Before prompt generation, a prompt engineer generates a prompt structure along with the rules and guidelines to generate the prompt. These rules and guidelines along with the prompt structure are sent to the prompt generator 116 which fetches and analyzes data from the data collector 114 and populates the prompt structure.

The prompt is to guide the AI engine 118 in generating images of the virtual character. The prompt engineer types a script based on the relevant information of the virtual character.

The prompt structure along with the rules and guidelines to generate the prompt for generating the animatable photorealistic images provided by the prompt engineer to the prompt generator 116 is given below:

photorealistic {historical_figure_name}; head and shoulders; facing the
camera --ar 9:16 --v 5.2

### Explanation

The animatable image generation system 110 receives input from the online learning platform 102 using the selector 112 as the user is studying a topic. The data collector receives 114 inputs from the selector 112 about the course the user is studying and accesses the relevant details about the virtual character using the virtual character data 108. The prompts include the details of the virtual character such as the figure's name, age, sex, era, and aspect ratio. For instance, to generate a figure of “George Washington” the following prompt is given:

photorealistic CGI of George Washington; head and shoulders; facing the
camera --ar 9:16 --v 5.2

The prompts for generating the animatable virtual character include parameters such as focusing on the head and shoulders, the image facing the camera, and the aspect ratio of the image to be 9:16. These parameters enhance the generation of animation of the photorealistic images of the virtual characters.

In operation 208, the prompt generator 116 transfers the generated prompts to the AI engine 118 to generate the photorealistic image of the virtual character by converting the text prompt into the photorealistic image based on one or more parameters.

The AI engine 118 guided by the prompt generator 116 interprets the details of the virtual character to generate a photorealistic image of the virtual character. The animatable image generation system 110 utilizes the AI engine 118 to generate the photorealistic image of the virtual character.

The prompt engineer codes the prompt structure using precise configuration and guides the AI engine 118 to generate photorealistic images of the virtual character. The Midjourney AI engine is used to combine different concepts to produce a photorealistic image of the virtual character. The midjournery model employs machine learning techniques including neural networks to enhance the realism and quality of the generated image based on the transferred prompts.

The AI image generator 120 is integrated into the AI engine 118 and uses the precise configuration of the prompts developed by prompt generator 116 to generate a photorealistic image of the virtual character. The AI image generator 120 focuses on image synthesis parameters, including visualization areas, scene settings, mood, lighting, color schemes, and camera angles. The AI image generator 120 makes a visually appealing and contextual image relevant to the educational material. The AI image generator 120 focuses on camera angles, head, and shoulders within the frame, the image looking directly at the camera to give photorealistic characters to the image. The AI image generator 120 utilizes real-time data to dynamically adjust image synthesis based on the interaction of the user with the learning platform 102.

The images produced by the AI engine 118 are stored in a cloud database 124 which can be later accessed by the animatable image generation system 110. The cloud database 124 includes the photorealistic images of the virtual character which can be further animated. In one of the embodiments, a Heygen tool is used for processing the generated images which can directly interact with the user. The Heygen tool can be utilized to animate the photorealistic images of the virtual character by creating lifelike movement and speech synchronization for the virtual character. The resulting talking head videos are designed to enhance the engagement and interactivity of the educational experience.

In some aspects, the image produced by the AI-driven prompt is not ideal for the generation of animatable virtual characters. The prompt generator 116 populates the AI engine 118 with the prompt structure as mentioned below:

photorealistic CGI of {{ figureName }} ({{ bio }} − {{ era }} −
{{ country }}
− {{ sex }} − {{ ageGroup }}); head and shoulders; eyes
looking at the camera
--ar 9:16 -v 5.2

### Explanation

The prompt generator 116 provides a different version of the prompt to regenerate the image of the virtual character. The prompt includes the figure's name, bio, era, country, age group of the virtual character, and other parameters such as eyes looking at the camera. The orientation of the image is crucial for the animation of the virtual character. Changes in the orientation can lead to distortion of the image making it less suitable for animation. The prompt eyes looking at the camera make the image suitable for the animation. The variation in prompts enhances the output of the image.

The AI engine 118 produces a photorealistic image of the virtual character. The text prompt is utilized by the AI engine 118 to generate an animatable virtual character. The AI engine 118 utilizes HeyGen to produce animatable images of the virtual character. The AI engine ensures that the images face the camera and have an aspect ratio of 9:16. The Heygen transforms the pictures into talking heads based on the parameters mentioned above which interact with the user.

In operation 210, a display module 122 receives the animatable virtual character images which are displayed to the user on the user interface 104 of the online learning platform 102.

The AI image generator 118 generates animatable virtual character images. The display module 122 receives the animatable historical figures from the AI engine 118 and integrates them with educational content items in a visually appealing and contextually appealing manner. The animatable historical figures provide relevant information related to the educational curriculum. The generated animatable historical figures enhance user engagement and enhance learning.

Below is the pseudocode to programmatically control generation of a photorealistic animatable image of the virtual character:

```
function generateHistoricalFigureImage (figureName) :
  prompt = createPrompt (figureName)
  image = midjourney. generateImage (prompt)
  if isValidImage (image) :
    return image
  else:
    return None
function createPrompt (figureName) :
  return f“photorealistic CGI of {figureName}; head and shoulders; facing
the camera --ar 9:16”
```

### Explanation

The data collector 114 collects details of the virtual character from the virtual character database 108 related to the content displayed to the user on the online learning platform 102. The function includes the generation of an image of the virtual character. The prompt generator 116 receives the input from the data collector 114 and transfers the prompt to AI image generator 120 to generate an animatable photorealistic image of the virtual character. If the image produced by the AI image generator 120 is appropriate, the image is stored in the cloud database 124, to further animate the virtual character. If the image is not appropriate variations in prompts are provided which include more precise details of the virtual character. The prompt includes details of the virtual character such as name, head, and shoulders in the image and the image looking directly into the camera.

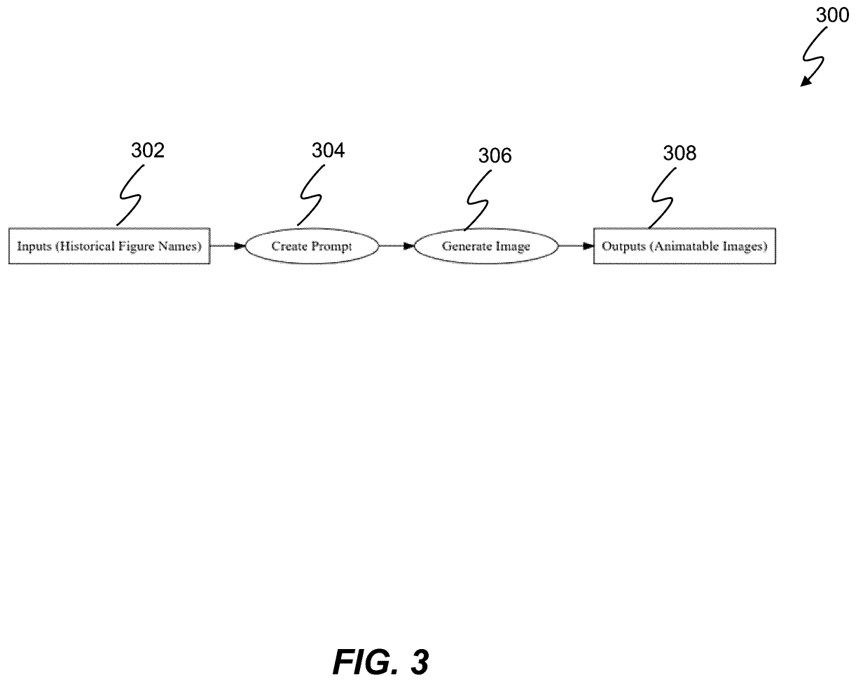

FIG. 3 depicts a flowchart 300 to generate animatable images of the virtual character.

The flowchart 300 depicts the steps involved in the generation of animatable images of the virtual character. Initially, the data collector 114 collects details of the virtual character from the virtual character database 108. The details input (historical figure names) 302. Once the details are collected, the prompt generator 116 creates a prompt 304 which is AI-based. The prompt generator 116 transfers the prompt to AI image generator 120 to generate the image. The AI engine 118 produces output (animatable images) 308 which is then displayed on the user interface 104.

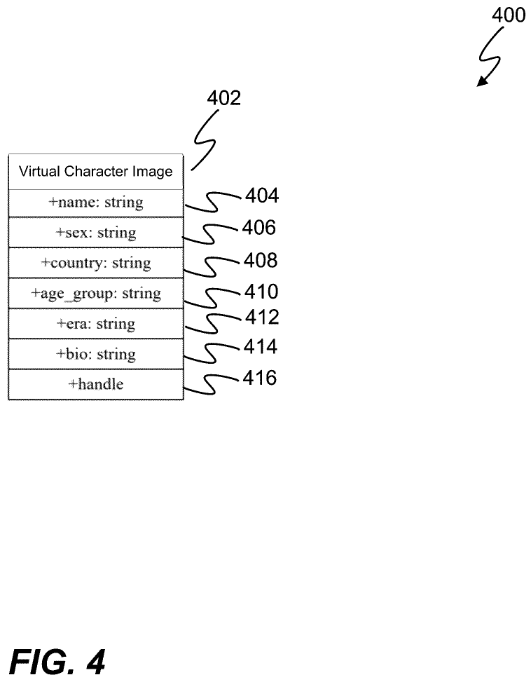

FIG. 4 depicts a data structure 400 used for the generation of an animatable photorealistic image of the virtual character using an AI image generator 120.

The data structure 400 includes a plurality of components which includes the name 404 of the virtual character, sex 406, country 408, age group 410, era 412 to which the virtual character belongs, bio 414, and handle 416. The information is stored in the virtual character database 108 and data collector 114 accesses this information to transfer the prompts to AI image generator 120 to produce an animatable photorealistic image of the virtual character.

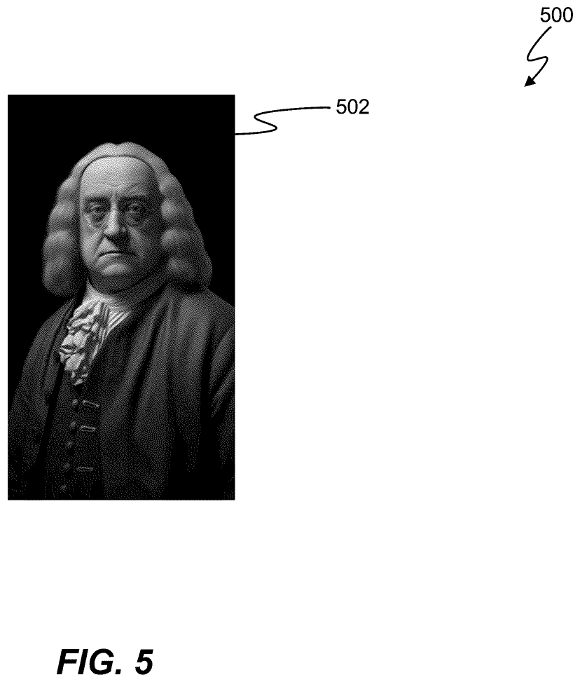

FIG. 5 depicts a user interface 500 displaying photorealistic image 500 generated using AI image generator 120. An exemplary prompt to generate animatable historical figure image:

generate photorealistic {historical_figure_name};
head and shoulders; facing
the camera --ar 9:16 --v 5.2

The user interface 500 displays the image of Benjamin Franklin 502. The name Benjamin Franklin is input to the prompt generator 116 to guide the AI image generator 120 to generate the photorealistic image of Benjamin Franklin. The prompt given to AI engine 118 includes:

generate photorealistic CGI of Benjamin Franklin;
head and shoulders; facing
the camera --ar 9:16 --v 5.2

Based on the prompts received by the AI image generator 120, the images are generated using mid-journey AI. The validated image is then used to create animatable videos that can be displayed to the user on the online learning platform 102.

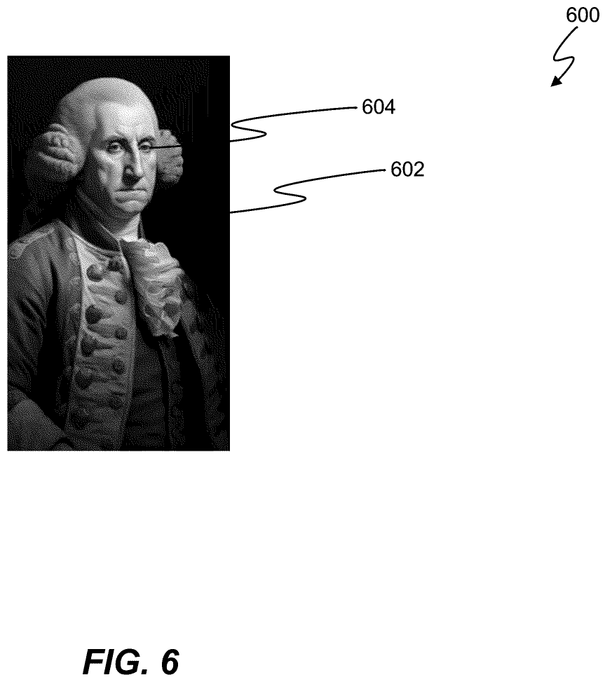

FIG. 6 depicts a user interface 600 displaying photorealistic image 600 generated using AI image generator 120.

The user interface 600 displays a photorealistic image of George Washington 602 crafted using mid-journey AI. The prompt given to AI engine 118 includes:

generate photorealistic CGI of George Washington;
head and shoulders; facing
the camera --ar 9:16 -v 5.2

However, in at least one embodiment, the image produced is not suitable for animation as the figure is not looking directly towards the camera 604 such that the animatable video will be distorted. Variations in prompts are given to AI image generator to regenerate an appropriate image of the virtual character. The prompt includes more detailed information about the virtual character. Below is a prompt representing the variations to generate an appropriate image.

generate photorealistic CGI of {{ figureName }} ({{ bio }} −
{{ era }} − {{
country }} − {{ sex }} − {{ ageGroup }}); head and shoulders;
eyes looking at
the camera --ar 9:16 -v 5.2

The prompt now includes more detailed information about the virtual character to produce an ideal image of George Washington.

In at least one embodiment, the animatable Figure Name, prompt, and images are stored in a data structure such as a table as illustratively set forth below. Each Figure can be depicted in one or more ways such as age, expression, dress, and likeness:

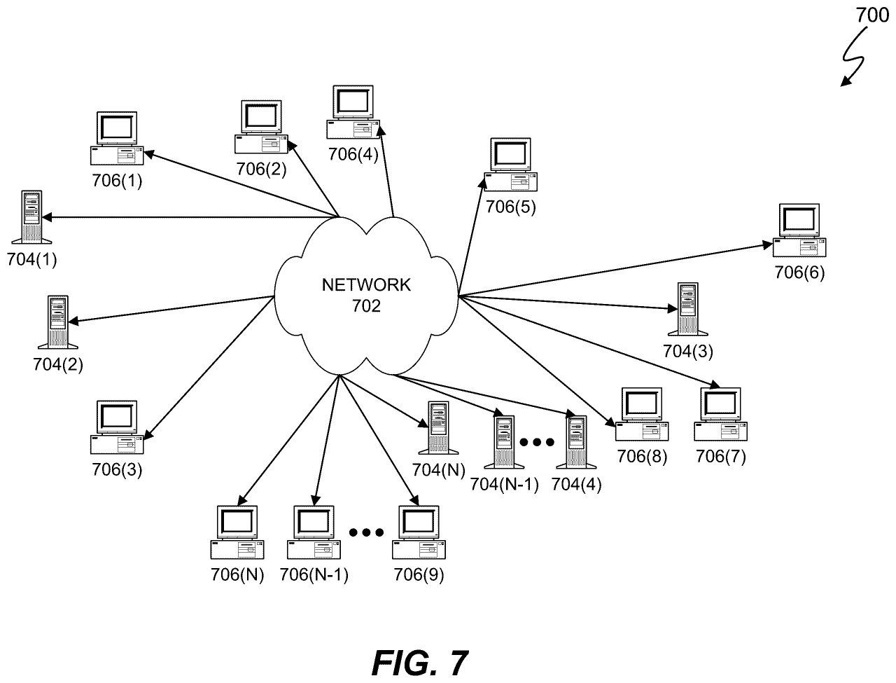

FIG. 7 is a block diagram illustrating a network environment in which an animatable image generation system 100 and animatable image generation process 200 may be practiced. Network 702 (e.g. a private wide area network (WAN) or the Internet) includes a number of networked server computer systems 704(1)-(N) that are accessible by client computer systems 706(1)-(N), where N is the number of server computer systems connected to the network. Communication between client computer systems 706(1)-(N) and server computer systems 704(1)-(N) typically occurs over a network, such as a public switched telephone network over asynchronous digital subscriber line (ADSL) telephone lines or high-bandwidth trunks, for example communications channels providing T1 or OC3 service. Client computer systems 706(1)-(N) typically access server computer systems 704(1)-(N) through a service provider, such as an internet service provider (“ISP”) by executing application specific software, commonly referred to as a browser, on one of client computer systems 706(1)-(N).

Client computer systems 706(1)-(N) and/or server computer systems 704(1)-(N) are specialized computer programmed to improve conventional computer systems to implement and utilize the an animatable image generation system 100 and animatable image generation process 200. The type of computer system that can be specially programmed to implement and utilize the an animatable image generation system 100 and animatable image generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the an animatable image generation system 100 and animatable image generation process 200 can be implemented using code stored in a tangible, non-transient computer readable medium and executed by one or more processors. In at least one embodiment, the an animatable image generation system 100 and animatable image generation process 200 can be implemented completely in hardware using, for example, logic circuits and other circuits including field programmable gate arrays.

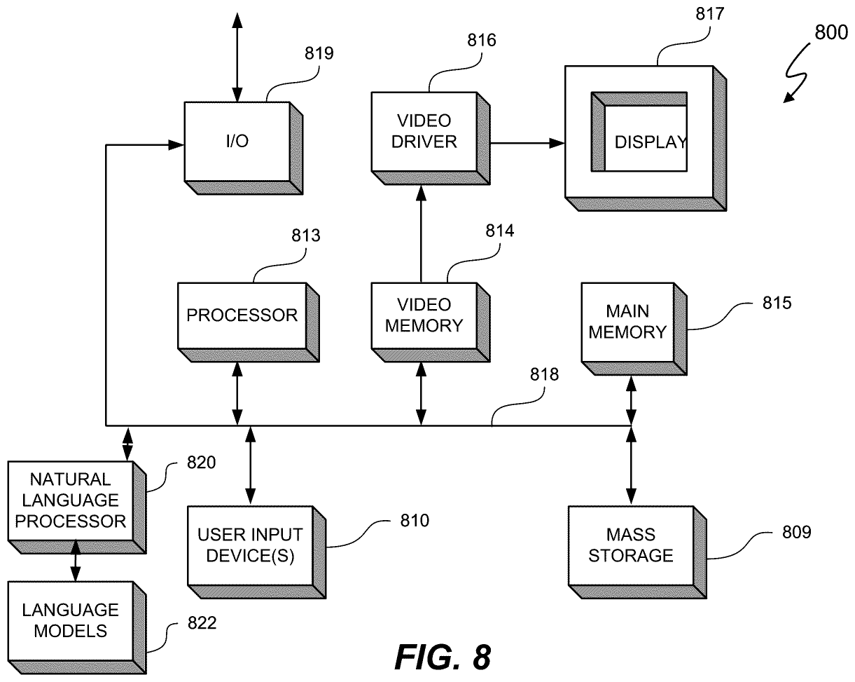

Embodiments of an animatable image generation system 100 and animatable image generation process 200 can be implemented on a computer system such as a special-purpose, special-programmed computer 800 illustrated in FIG. 8. Input user device(s) 810, such as a keyboard and/or mouse, are coupled to a bi-directional system bus 818. The input user device(s) 810 are for introducing user input to the computer system and communicating that user input to processor 813. The computer system of FIG. 8 generally also includes a non-transitory video memory 814, non-transitory main memory 815, and non-transitory mass storage 809, all coupled to bi-directional system bus 818 along with input user device(s) 810 and processor 813. The mass storage 809 may include both fixed and removable media, such as a hard drive, one or more CDs or DVDs, solid state memory including flash memory, and other available mass storage technology. Bus 818 may contain, for example, 32 of 64 address lines for addressing video memory 814 or main memory 815. The system bus 818 also includes, for example, an n-bit data bus for transferring DATA between and among the components, such as CPU Y09, main memory 815, video memory 814 and mass storage 809, where “n” is, for example, 32 or 64. Alternatively, multiplex data/address lines may be used instead of separate data and address lines.

I/O device(s) 819 may provide connections to peripheral devices, such as a printer, and may also provide a direct connection to a remote server computer systems via a telephone link or to the Internet via an ISP. I/O device(s) 819 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 809, into main memory 815 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 813, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 815 is comprised of dynamic random access memory (DRAM). Video memory 814 is a dual-ported video random access memory. One port of the video memory 814 is coupled to video amplifier 816. The video amplifier 816 is used to drive the display 817. Video amplifier 816 is well known in the art and may be implemented by any suitable means. This circuitry converts pixel DATA stored in video memory 814 to a raster signal suitable for use by display 817. Display 817 is a type of monitor suitable for displaying graphic images.

The computer system described above is for purposes of example only. The an animatable image generation system 100 and animatable image generation process 200 may be implemented in any type of computer system or programming or processing environment. It is contemplated that the an animatable image generation system 100 and animatable image generation process 200 might be run on a stand-alone computer system, such as the one described above. The an animatable image generation system 100 and animatable image generation process 200 might also be run from a server computer systems system that can be accessed by a plurality of client computer systems interconnected over an intranet network. Finally, the an animatable image generation system 100 and animatable image generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to generate a photorealistic image of a virtual character in correspondence to educational content provided to a user using an online learning platform, the method comprises:
executing code using one or more processors of a computer system to cause the computer system to perform operations comprising:
selecting the virtual character based on the educational content provided to the user using the online learning platform;
accessing historical databases, and educational databases to collect information about the virtual character;
generating a prompt to guide the AI engine to generate the photorealistic image of the virtual character;
transferring the prompt to the AI engine to create the photorealistic image of the virtual character by converting the text prompt into the photorealistic image based on one or more parameters;
receiving the photorealistic image of the virtual character in correspondence to the educational content items, wherein the generated image is generated specifically to enhance user engagement and experience that is visually appealing and contextually appropriate.

2. The method of claim 1 wherein the virtual character is an Artificial Intelligence generated real-time tutor who guides the user, thereby providing an engaging, and learning environment.

3. The method of claim 1 wherein the details of the virtual characters collected from one or more databases include the virtual character's name, sex, country, biographic data, age, and era to which the virtual character belongs.

4. The method of claim 1 wherein the generated images are designed to be used in the online learning platforms, where the virtual character can interact with the user to make the learning experience more engaging and interactive.

5. The method of claim 1 wherein the one or more parameters generated by the generated photorealistic image includes images focused on the head and shoulders, images facing the camera, and a 9:16 aspect ratio to ensure suitability for animation and interactive use in educational settings.

6. The method of claim 1 wherein the educational content is collected from the online learning platform.

7. The method of claim 1 wherein the prompts are generated by the text details that focus on image synthesis parameters, including visualization areas, scene settings, mood, lighting, color schemes, and camera angles.

8. The method of claim 1 wherein the generation of prompts for guiding the AI engine further comprises:
specifying a visual style for the image based on the educational content provided to the user;
integrating the visual style specifications into the text prompt to generate the image, including head and shoulder, color details, brightness, camera angle, age, clothing, and facial expression; and
adapting the visual style to reflect the generated image of the virtual character to make it visually appealing and contextually relevant to the educational material.

9. The method of claim 1 wherein the image generation utilizes real-time data analysis to dynamically adjust image synthesis parameters based on ongoing user interactions and learning progress.

10. The method of claim 1 further comprises:
animating the generated photorealistic images of the virtual character by creating lifelike movement and speech synchronization for the virtual character; and
resulting talking head videos are designed to enhance the engagement and interactivity of the educational experience by making the virtual characters appear as if they are interacting directly with the audience;

11. The method of claim 1 wherein the AI engine employs machine learning techniques, including neural networks, to enhance the realism and artistic quality of the generated image based on the transferred prompts.

12. A system that integrates programmatic control and a guided and constrained Artificial Intelligence (AI) engine to generate a photorealistic image of a virtual character in correspondence to educational content provided to a user using an online learning platform comprises:
one or more processors of a computer system; and
a memory, coupled to the one or more processors, storing code that when executed causes the computer system to perform operations comprising:
selecting the virtual character using a selector based on the educational content provided to the user using the online learning platform;
accessing historical databases, and educational databases to collect information about the virtual character using a data collector;
generating a prompt using a prompt generator to guide the AI engine to generate the photorealistic image of the virtual character;
transferring the prompt to the AI engine to create the photorealistic image of the virtual character by converting the text prompt into the photorealistic image based on one or more parameters using a AI image generator;
receiving the photorealistic image of the virtual character in correspondence to the educational content items using a display module, wherein the generated image is generated specifically to enhance user engagement and experience that is visually appealing and contextually appropriate.

13. The system of claim 12 wherein the generated image of the virtual character is displayed to the user on a user interface integrated within the online learning platform.

14. The system of claim 12 wherein the generated images are stored in a cloud database accessible to the online learning platform for reuse and reference in future online learning sessions.

15. The system of claim 12, wherein the display module is configured to receive the photorealistic image of the virtual character and integrate it with the educational content items in a visually appealing and contextually appropriate manner, enhances user engagement and learning experience.

16. The system of claim 12 wherein the image generation utilizes neural network for optimized real-time processing and adaptation of image synthesis parameters, ensuring timely generation of contextually appropriate visuals aligned with educational standards.
